(19) United States
(12) Patent Application Publication
(10) Pub. No.: US 2008/0100426 A1
(43) Pub. Date: May 1, 2008

(54) HITCH MOUNTED CARRIER ALARM METHOD

(75) Inventors: D. Scott KALOUS, Kenosha, WI (US); Steve HEDLUND, Racine, WI (US)

Correspondence Address: CALFEE, HALTER & GRISWOLD LLP, 1400 KEYBANK CENTER, 800 SUPERIOR AVENUE, CLEVELAND, OH, 44114, US

(73) Assignee: MASTER LOCK COMPANY LLC, Oak Creek, WI (US)

(21) Appl. No.: 11/928,184

(22) Filed: Oct. 30, 2007

Related U.S. Application Data
(60) Provisional application No. 60/855,639, filed on Oct. 31, 2006.

(51) Int. Cl. B60R 25/10

(52) U.S. Cl. 340/426.22

(57) ABSTRACT

For a cargo alarm system cargo is secured to a storage location, such as, for example, a vehicle by coupling a signal carrying device between the storage location and the cargo. The signal carrying device, which may be, for example, a flexible electrically conducting tether, provides a closeable alarm signal loop between the storage location and the cargo. An alarm signal is transmitted on the signal carrying device and in turn the alarm signal is received on the signal carrying device. An alert signal is provided when the alarm signal is not received from the signal carrying device.

### CROSS REFERENCE TO RELATED APPLICATIONS

This application claims the benefit of priority from U.S. Provisional Patent No. 60/855,639 entitled Hitch Mounted Carrier Alarm, filed on Oct. 31, 2006 and incorporated herein by reference in its entirety to the extent that it does not conflict with the present disclosure.

### FIELD OF THE INVENTION

This invention relates to vehicle alarm systems and to alarms for hitch mounted carriers attached to vehicles.

### BACKGROUND OF THE INVENTION

Hitch mounted carriers can be designed to couple or otherwise attach to a truck, sports utility vehicle, or other such vehicle equipped with a trailer hitch. Hitch mounted carriers can be designed for carrying bicycles, skis, and other valuable items. During use, the hitch mounted carrier is often left unattended while the driver stops, such as, for example, to rest for the night or eat a meal. Such circumstances leave the hitch mounted carrier cargo susceptible to theft.

The hitch mounted carrier itself can also be a valuable item. Many hitch mounted carriers are designed for a specific purpose, such as carrying bicycles and, as a result, can be relatively expensive. Bicycles are often towed to a trail location, removed from the hitch mounted carrier, and put into use. This leaves the vehicle, the hitch mounted carrier coupled to the vehicle, and the remaining cargo mounted to the carrier unattended and a potential target of theft.

### SUMMARY

In an embodiment of the invention, cargo is secured to a storage location, such as, for example, a vehicle by coupling a signal carrying device between the storage location and the cargo. The signal carrying device, which may be, for example, a flexible electrically conducting tether, provides a closeable alarm signal loop between the storage location and the cargo. An alarm signal is transmitted on the signal carrying device and in turn the alarm signal is received on the signal carrying device. An alert signal is provided when the alarm signal is not received from the signal carrying device.

### DESCRIPTION OF THE DRAWINGS

In the accompanying drawings, which are incorporated in and constitute a part of this specification, embodiments of the invention are illustrated, which, together with the description of the invention serve to illustrate the principles of this invention. The drawings and detailed description are not intended to and do not limit the scope of the invention or any subsequent claims in any way. Instead, the drawings and description only describe embodiments of the invention and other embodiments of the invention not described are encompassed by this disclosure of the invention.

FIG. 1 is a perspective view of a hitch mounted carrier that can be used in practice of an embodiment of the present invention;

FIG. 2 is a schematic view of an embodiment of a hitch mounted carrier alarm arranged in accordance with an embodiment of the present invention;

FIG. 3 is a flowchart outlining an example of a procedure that can be used to operate a hitch mounted carrier alarm arranged in accordance with an embodiment of the present invention;

FIG. 4 is a perspective view of a portion of a hitch mounted carrier alarm system arranged in accordance with an embodiment of the present invention;

FIG. 5 is a perspective view of a portion of a hitch mounted carrier alarm system arranged in accordance with an embodiment of the present invention;

FIG. 6 is a perspective view of a portion of a hitch mounted carrier alarm system arranged in accordance with an embodiment of the present invention; and

FIG. 7 is a schematic view of a bicycle installed on a hitch mounted carrier that includes a carrier alarm system constructed in accordance with an embodiment of the present invention.

### DETAILED DESCRIPTION

The Detailed Description of the Invention merely describes preferred embodiments of the invention and is not intended to limit the scope of the claims in any way. Indeed, the invention as described by any claims and specification is broader than and unlimited by the preferred embodiments, and the terms in any claims and specification have their full ordinary meaning.

This invention and disclosure are directed to methods and apparatus for securing cargo to a storage location. In particular, the described embodiments involve hitch mounted carriers coupled to towing vehicles to prevent the theft of the hitch mounted carrier or its cargo. The described methods and apparatus are designed to detect when a hitch mounted carrier or its cargo is separated from the towing vehicle. In addition, the methods and apparatus can be designed to alert the owner or others that the hitch mounted carrier or its cargo is separated from the towing vehicle such as, for example, when cargo is improperly secured. In one embodiment, this alert can take the form of an audible alert, such as a siren. The present invention may be practiced in connection with any type of cargo that is desired to be secured to a storage location.

“Signal communication” as used herein is used to indicate a relationship between devices that allows for communication of a signal, in this particular case, the alarm signal. Direct electrical, optical, and electromagnetic connections and indirect electrical, optical, and electromagnetic connections are examples of signal communication. Two devices are in signal communication if a signal from one may be received by the other, regardless of whether the signal is modified by some other device. For example, two devices separated by one or more of the following—transformers, optoisolators, digital or analog buffers, analog integrators, other electronic circuitry, fiber optic transceivers, or even satellites—are in signal communication if a signal from one reaches the other, even though the signal is modified by the intermediate device(s). As another example, two devices not directly connected to each other (e.g. keyboard and memory), but both in signal communication with a third device, (e.g., a CPU), are in signal communication.

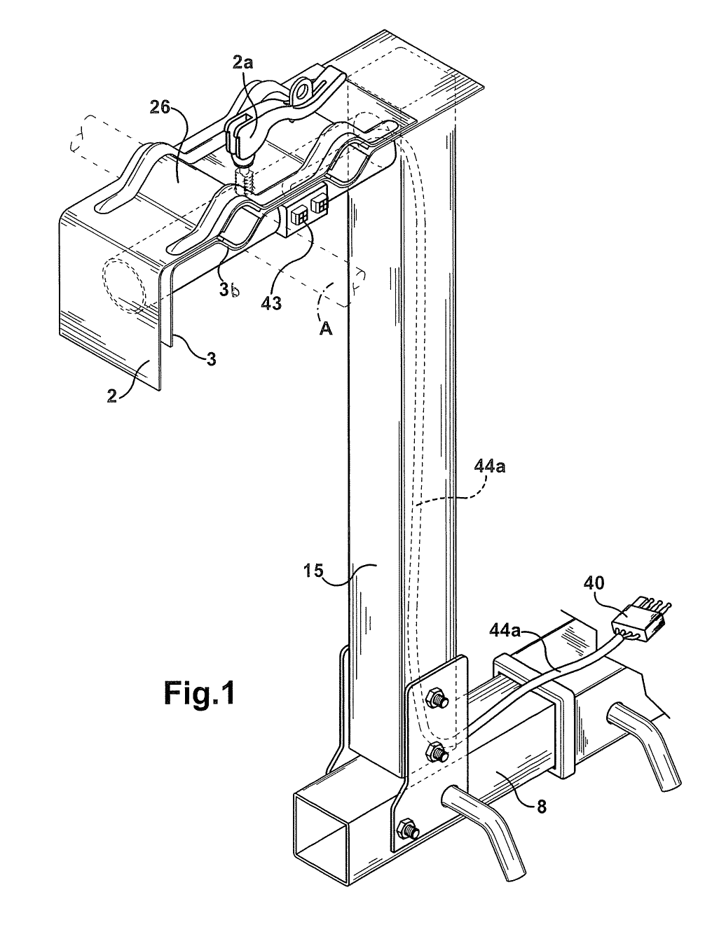

Referring to FIG. 1, a hitch mounted bicycle carrier 15 is shown. The hitch mounted bicycle carrier 15 is configured to mount into a hitch receiver on a vehicle via a draw bar 8. The hitch mounted carrier includes top and bottom plates 2, 3 that include clamping features 2b, 3b. To secure one or more bicycles to the carrier, each bicycle frame, denoted A and B, is placed in a clamping feature 3b on the bottom plate 3. The top plate 2 is placed on top of the bicycle frame so that the clamping feature 2b covers the exposed portion of the bicycle frame. The plates 2, 3 are secured to one another using a screw 2a or other mechanism. The bicycles will remain secured to the carrier 15 until they are removed by loosening the screw 2a and removing the top plate 2. For the purposes of this description, reference will be made to the hitch mounted bicycle carrier 15. However, any vehicle mounted carrier that secures one or more articles can be used in practice of the present invention.

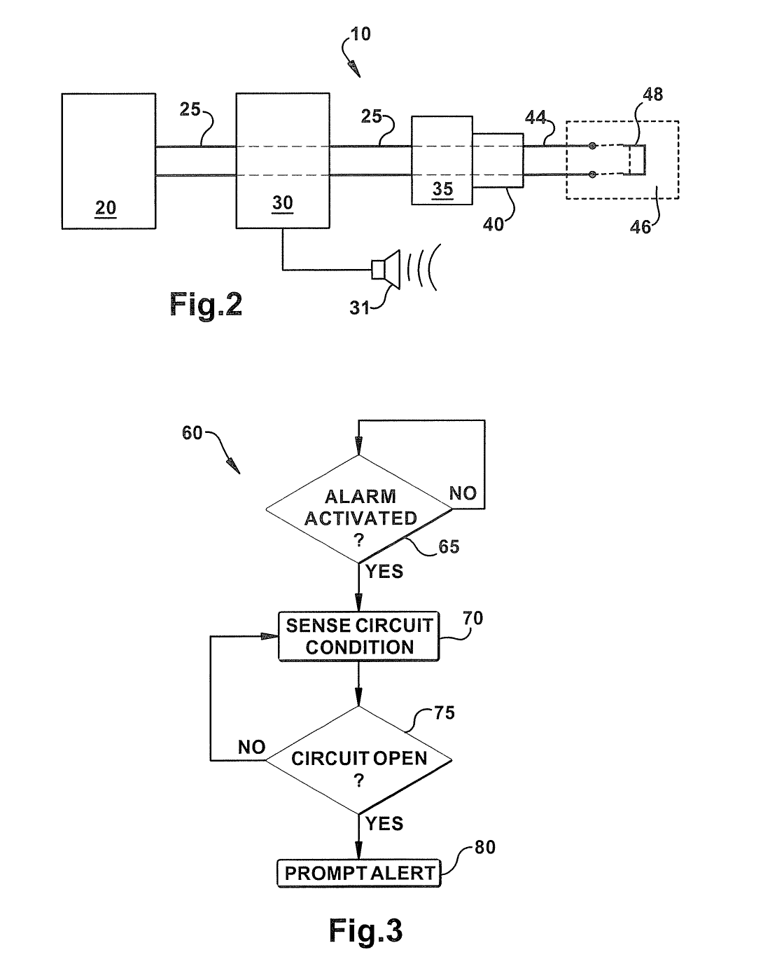

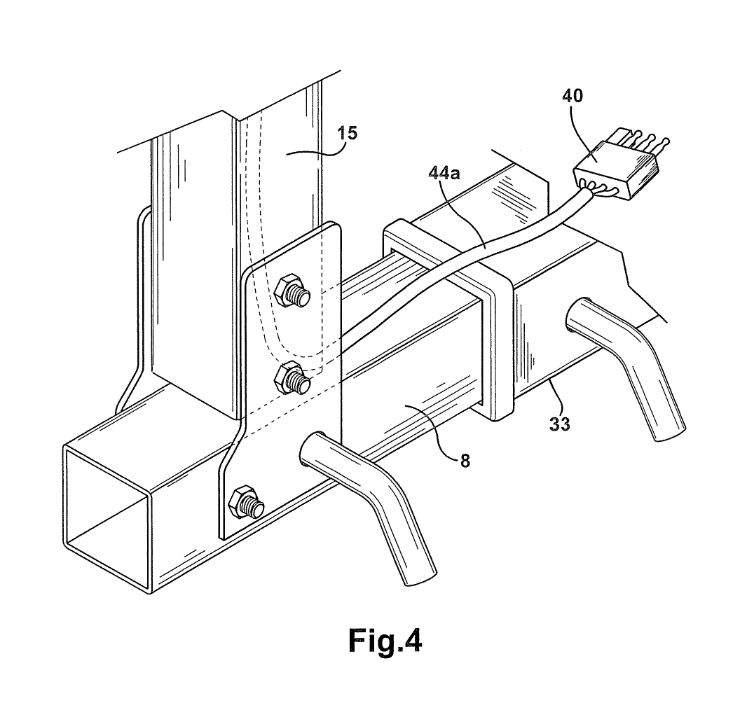

Referring to FIG. 2, an electrical schematic diagram of an exemplary embodiment of a hitch mounted carrier alarm system 10 is shown. An alarm unit 30 is electrically connected to a towing vehicle 20 by the vehicle's wiring harness 25 that carries electrical power and signals from a towing vehicle's electrical system to various vehicle systems. The wiring harness 25 includes a hitch receptacle 35. The hitch receptacle is configured to accept a plug from a trailer or other hitch mounted device. The plug connects the hitch mounted device to the towing vehicle's electrical system and can be used to activate trailer signal lights or provide power to any hitch mounted device. As can also be seen in FIGS. 1 and 4, when the hitch mounted carrier alarm system is installed on the vehicle, a carrier connector 40 is plugged into the receptacle 35. One or more electrical tethers 44 form a closeable electric circuit through the connector 40. An alarm switch 48 closes the circuit formed by the tethers 44.

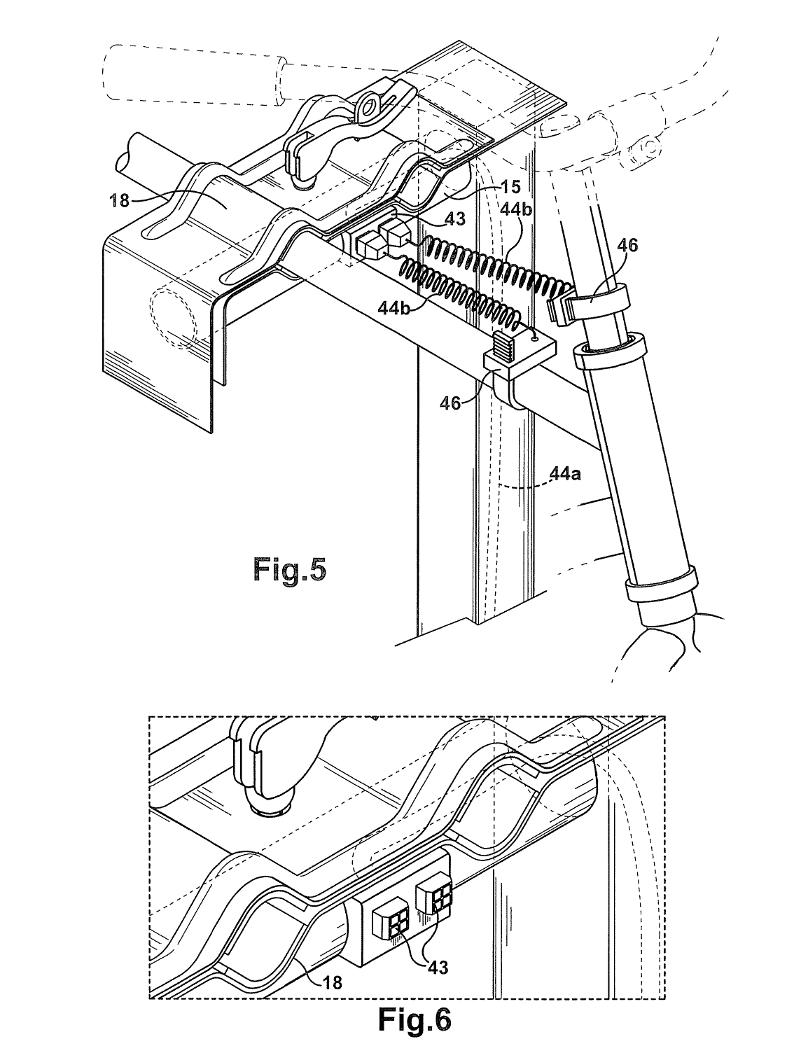

FIG. 4 is a view of a portion of the hitch mounted bicycle carrier 15 that includes a signal carrying device, a wiring harness 44a and flexible tethers 44b (FIG. 5) in the described embodiment, that carries signals from the alarm unit around the cargo and back to the alarm unit along a closeable loop alarm signal path. The carrier includes the carrier plug 40 that plugs into the hitch receptacle 30(FIG. 2). The hitch mounted bicycle carrier 15 is mounted in the towing vehicle's hitch receiver 33. The hitch receiver can also accept draw bars with a ball on which to mount a trailer. The carrier plug 40 is connected to a carrier wiring harness 44a that can be routed internally through the carrier 15 as shown in FIGS. 1 4, or run outside the carrier. The carrier wiring harness exits the carrier structure through carrier outlets 43, which can be seen in FIGS. 5 and 6. The wiring harness 44a continues in the form of flexible tether cords 44b that plug into the outlets 43 and terminate in a carrier alarm clamp 46.

The carrier alarm clamp 46 is configured to be placed around a frame or other component of the bicycle being carried by the carrier 15. The carrier alarm clamp can be adapted to be placed around any type of cargo. The carrier alarm clamp is opened to allow it to be installed on the bicycle and is closed to secure it to the bicycle. The carrier alarm clamp may be constructed so that it is mechanically biased to the closed position. The carrier alarm clamp 46 includes an internal alarm switch 48 that is movable between an open position shown in solid lines in FIG. 2 and a closed position shown in phantom. The alarm switch is mechanically coupled to the carrier alarm clamp 46 such that when the clamp is closed, the switch is closed and when the clamp is open, the switch is open. When the alarm switch is in its closed position, a closed alarm circuit exists from the electrical system of the towing vehicle 20 through the alarm unit and the hitch mounted bicycle carrier. The alarm unit includes circuitry that detects whether the alarm circuit is open or closed.

The carrier alarm clamp 46 that houses the alarm switch 48 may be integrated as part of a bicycle clamping mechanism, shown in FIGS. 5 and 6 as 18, which is similar in operation to the clamping mechanism with top and bottom plates 2, 3 of FIG. 1. In this case, the alarm switch 48 is in its closed position when the clamping mechanism is closed and the alarm switch is open when the clamping mechanism is open.

FIG. 3 is a flowchart that illustrates one procedure 60 that can be used by the alarm unit 30 to activate an alert mechanism when either the hitch mounted bicycle carrier 15 or a bicycle mounted to the hitch mounted bicycle carrier is removed. At 65, the alarm unit senses whether it has been activated. For example, the alarm unit may be activated by a user with a remote control or a mechanical switch on the towing vehicle. If the alarm unit is not activated, it will not actuate an alert signal based on the alarm circuit condition. If the alarm unit is activated, the condition of the alarm unit is sensed at 70. The alarm unit may sense the circuit condition by sending a test signal through the circuit and monitoring the circuit for a proper response. At 75, if the alarm unit does not sense an open alarm circuit, no action is taken and the sensing process continues. If an open circuit is sensed, at 80 the alarm unit prompts the alert mechanism.

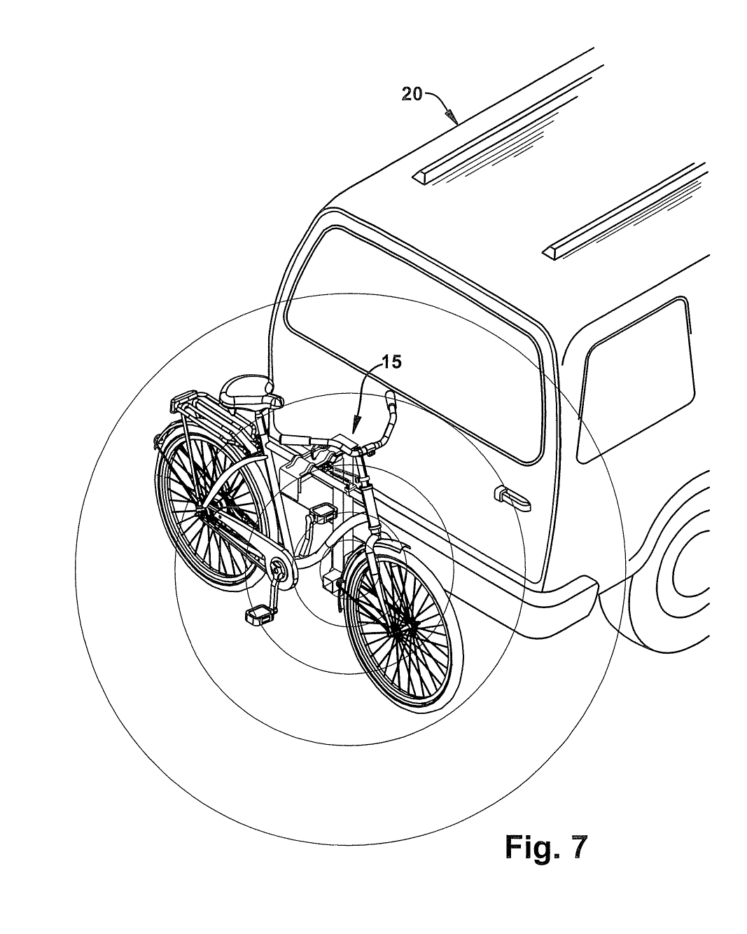

By setting up and monitoring a closed alarm circuit, the alarm unit can provide the alert mechanism in response to disruption of the alarm circuit caused by tampering with any carrier alarm system component. FIG. 7 shows a bicycle installed on a carrier 15. When a thief tampers with the carrier, an alarm is sounded. For example, if the carrier plug 40 is unplugged the circuit will be opened. If the clamp is opened or broken, the circuit will be opened. If the carrier wiring harness is cut in any location, the alarm circuit will be opened. If any of these events, and other predetermined events, occur while the alarm is activated, an alert signal will be provided.

While various aspects of the invention are described and illustrated herein as embodied in combination in the exemplary embodiments, these various aspects may be realized in many alternative embodiments not shown, either individually or in various combinations and sub-combinations thereof. Unless expressly excluded herein all such combinations and sub-combinations are intended to be within the scope of the present invention. Still further, while various alternative embodiments as to the various aspects and features of the invention, such as alternative materials, structures, configurations, methods, devices, and so on may be described herein, such descriptions are not intended to be a complete or exhaustive list of available alternative embodiments, whether presently known or later developed. Those skilled in the art may readily adopt one or more of the aspects, concepts or features of the invention into additional embodiments within the scope of the present invention even if such embodiments are not expressly disclosed herein. Additionally, even though some features, concepts or aspects of the invention may be described herein as being a preferred arrangement or method, such description is not intended to suggest that such feature is required or necessary unless expressly so stated. Still further, exemplary or representative values and ranges may be included to assist in understanding the present invention however; such values and ranges are not to be construed in a limiting sense and are intended to be critical values or ranges only if so expressly stated.

We claim:

1. A method that secures cargo carried on a vehicle comprising the steps of:
coupling a signal carrying device between the vehicle and the cargo, the signal carrying device providing a closeable alarm signal loop between the vehicle and the cargo;
transmitting an alarm signal on the signal carrying device;
receiving the alarm signal on the signal carrying device; and
providing an alert signal when the alarm signal is not received from the signal carrying device.

2. The method of claim 1 wherein the step of coupling a signal carrying device between the vehicle and the cargo is performed by connecting a signal conducting tether to a vehicle wiring harness.

3. The method of claim 1 wherein the step of coupling a signal carrying device between the vehicle and the cargo is performed by connecting a signal conducting tether to the cargo with a clamp.

4. The method of claim 1 wherein the step of coupling a signal carrying device is performed by closing a signal conducting clamp that is disposed within the alarm signal loop around the cargo.

5. A method that secures cargo to a vehicle comprising:
mechanically coupling a cargo carrier to the vehicle;
electrically coupling the cargo carrier to an alarm circuit in the vehicle;
securing cargo to the cargo carrier;
electrically connecting a signal carrying tether to the cargo carrier, wherein the signal carrying tether is configured to provide a closeable loop tether path that is part of the alarm circuit;
mechanically engaging the cargo with the tether;
monitoring an electrical condition of the alarm circuit; and
providing an alert signal if the closeable loop path is open.

6. The method of claim 5 wherein the step of electrically coupling the cargo carrier to the alarm circuit is performed by connecting a cargo carrier wiring harness to a trailer wiring connector.

7. The method of claim 5 wherein the step of electrically connecting a signal carrying tether to the cargo is performed by inserting a tether connector into a tether receptacle disposed on the cargo carrier, the tether receptacle being configured to provide an electrical connection to the alarm circuit.

8. The method of claim 5 wherein the step of mechanically engaging the cargo is performed by engaging the cargo with a closeable clamp that is connected to a distal end of the tether.

9. The method of claim 8 wherein the closeable clamp is configured to be placed in the closeable loop tether path and such that the closeable loop path becomes open when the clamp is placed in an open position.
